(19) United States
(12) Patent Application Publication
(10) Pub. No.: US 2026/0077962 A1
(43) Pub. Date: Mar. 19, 2026

(54) ELECTROMAGNETIC LANER

(71) Applicant: Laitram, L.L.C., Harahan, LA (US)

(72) Inventors: Benson Hall, Harahan, LA (US); Bryant G. Ragan, Metairie, LA (US)

(21) Appl. No.: 19/115,012

(22) PCT Filed: Oct. 19, 2023
(86) PCT No.: PCT/US2023/077251

§ 371 Date: Mar. 25, 2025

Related U.S. Application Data
(60) Provisional application No. 63/421,355, filed on Nov. 1, 2022.

(51) Int. Cl. B65G 47/71; B65G 21/20; B65G 47/28; B65G 54/02

(52) U.S. Cl. CPC B65G 47/71; B65G 21/2072; B65G 47/28; B65G 54/02; B65G 2201/0252; B65G 2203/0233; B65G 2811/0621

(57) ABSTRACT

A conveyor and a related method for organizing electrically conductive articles such as aluminum cans, into single-file lanes. Parallel rails divide the conveying surface of a conveyor belt into lanes across the width of an upper belt run. Upstream electro-magnetic coil sets in line with each rail produce magnetic fields that interact with the conductive cans to produce forces that pre-arrange the cans into lanes between the coil sets for presentation to the lanes between the rails already in line. In that way, damaging collisions between the cans and the ends of the rails are avoided.

### BACKGROUND

The invention relates generally to power-driven conveyors and particularly to belt conveyors using electromagnetic coils to arrange a mass of electrically conductive articles into lanes and a related method for laning electrically conductive articles.

In the beverage industry, laning conveyors, or laners, unscramble a crowd of randomly or tightly spaced cans or bottles and divide them into parallel single-file lanes in which the cans or bottles are conveyed. The cans or bottles are delivered lane by lane to different processing machines or to packers for packing into boxes. Most laners have a series of parallel rails that divide the conveyor into multiple lanes. But the flow of cans or bottles into the lanes is disrupted by collisions between the crowd of cans or bottles and the upstream ends of the rails. The collisions can increase inter-can or-bottle spacing in the single-file lanes, which reduces throughput. And collisions can also dent or mar the sides of the cans or bottles.

### SUMMARY

One version of a conveyor for laning electrically conductive articles comprises an upper run extending in length from an entrance to an exit downstream and laterally in width from a first side to a second side. A conveyor belt is configured to convey electrically conductive articles along the upper run from the entrance to the exit in a conveying direction. Rails spaced apart across the width of the upper run and extending along the length of the upper run from first ends to second ends downstream of the first ends form lanes along the length of the conveyor belt separated by the rails. Electromagnetic coil sets extend upstream from the first ends of the rails toward the entrance of the upper run. Each of the electromagnetic coil sets is in line with one of the rails. The electromagnetic coil sets produce magnetic fields that interact with the electrically conductive articles to repel the electrically conductive articles and force a mass of the electrically conductive articles received at the entrance of the upper run to form files between consecutive electromagnetic coil sets for delivery to the first ends of the rails in line with the lanes.

One method for organizing a mass of electrically conductive articles into lanes for delivery to lane-forming rails comprises: (a) feeding a mass of electrically conductive articles onto a conveyor belt advancing in a conveying direction along an upper run from an entrance to an exit; (b) conveying the electrically conductive articles from the entrance to the exit on a conveying surface of the conveyor belt; (c) forming lanes spaced apart across the width of the conveyor between rails extending along the upper run above the conveying surface in the conveying direction from a first end nearer the entrance to a second end; and (d) producing magnetic fields in electromagnetic coil sets extending in line with the rails from the first ends of the rails toward the entrance to repel the electrically conductive articles and force the mass of electrically conductive articles received at the entrance of the upper run to form files between consecutive electromagnetic coil sets for delivery to the first ends of the rails already aligned with the lanes.

### BRIEF DESCRIPTION OF THE DRAWINGS

FIG. 1 is a top plan view of the entrance portion of a laning conveyor embodying features of the inventions.

FIG. 2 is a front elevation view of the conveyor of FIG. 1.

FIG. 3 is a top plan view of the conveyor of FIG. 1 showing cans being arranged single-file in lanes.

### DETAILED DESCRIPTION

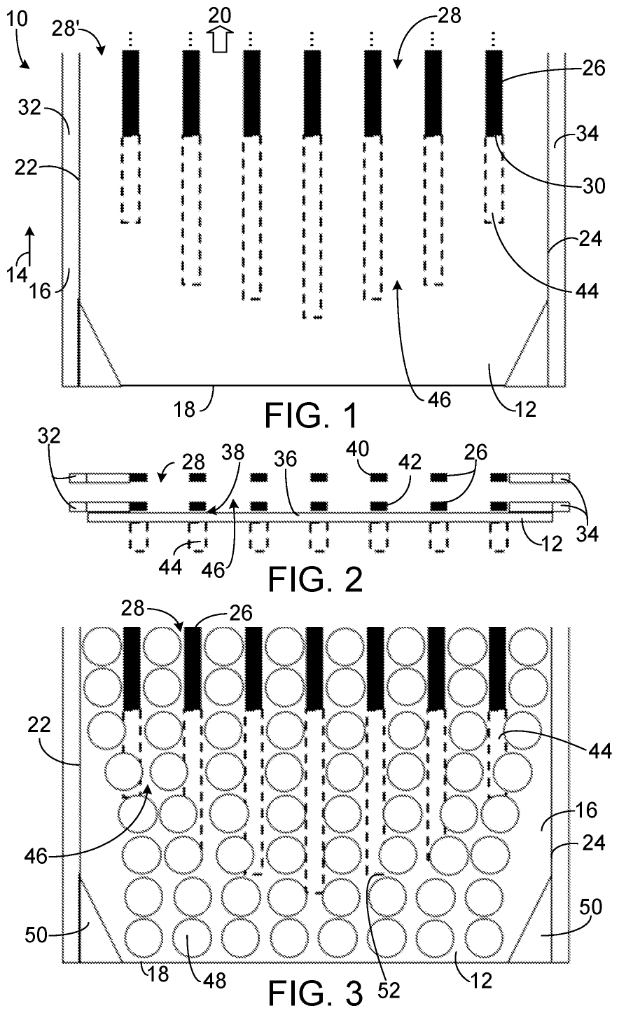

The entrance end of a laning conveyor is shown in FIGS. 1 and 2. The laning conveyor, or laner 10, includes a conveyor belt 12 advancing in a conveying direction 14 along an upper belt run 16. The upper run 16 extends in length in the conveying direction 14 from an entrance 18 downstream to an exit 20. The upper run 16 extends laterally in width from a first side 22 to a second side 24. At the exit 20 the conveyor belt 12 changes direction around sprockets or pulleys for its return along a lower belt return (not shown) back to the entrance 18.

Rails 26 spaced apart laterally across the width of the conveyor belt 12 divide the belt's conveying surface into parallel lanes 28 separated by the rails. The rails 26 extend downstream from first ends 30 to second ends near the exit 20 of the upper run 16. Left and right side rails 32, 34 at the first and second sides 22, 24 of the upper run 16 form outer lanes 28′with the outermost interior rails 26. The side rails 32, 34 extend the length of the upper run from the entrance 18 to the exit 20. The interior rails 26 are elevated above the conveying surface 36 of the belt 12 across gaps 38. The gaps 38 are shorter than the heights of articles conveyed on the belt 12. In this example, each interior rail 26 is made of two rail bars: an upper rail bar 40 and a lower rail bar 42. But the rails could be made of a single bar or of more than two bars.

Linear arrays of electromagnetic coil sets 44 in the upper run slightly below the conveyor belt 12 extend from the first ends 30 of the interior rails 26 upstream toward the entrance 18 of the upper run 16. Each of the electromagnetic coil sets 44 is in line with one of the rails 26. Contactless lanes 46 formed between consecutive coil sets 44 are in line with the lanes 28 between consecutive rails 26. The lanes 46 are termed contactless because there is no physical rail 26 in that portion of the upper run 16. The electromagnetic coil sets 44 are energized to produce magnetic fields that pass through the conveyor belt 12 and interact with electrically conductive articles, such as aluminum cans 48 as shown in FIG. 3. The magnetic fields induce currents in the cans 48 as they are conveyed on the belt 12. The induced currents in the cans 48 produce electromagnetic fields that interact with the magnetic fields of the coil sets 44 to generate forces that repel the cans away from the coil sets and into the contactless lanes 46 in single files. The widths of the physical lanes 28 and the contactless lanes 46 are slightly greater than the diameter of the cans 48 for single-file laning. Because the contactless lanes 46 are aligned with the lanes 28 between the rails 26, the cans 48 are contactlessly pre-laned upstream of the rails. In that way, collisions between the cans 48 and the first ends 30 of the rails 26 are prevented. And dents and scratches on the sides of the cans are avoided.

As shown in FIG. 3, the cans 48 are fed onto the conveyor belt 12 in a configuration narrower than the width of the upper run 16. Optional wedge-shaped restrictors 50 at the first and second sides 22, 24 of the upper run 16 angle toward each other and the entrance 18 to restrict the width of the conveyor 10 to entering cans 48. For that reason, the electromagnetic coil sets 44 also spread the cans 48 while organizing them into the contactless lanes 46. If the incoming cans 48 are randomly spaced in a configuration as wide as the upper run 16, the electromagnetic coil sets 44 direct the cans into the lanes 46. To aid the spreading of the cans 48, upstream ends 52 of the coil sets 44 decrease in distance from the entrance 18 away from the first and second sides 22, 24 of the upper run 16 toward its centerline.

What is claimed is:

1. A conveyor for laning electrically conductive articles comprising:
an upper run extending in length from an entrance to an exit downstream and laterally in width from a first side to a second side;
a conveyor belt configured to convey electrically conductive articles along the upper run from the entrance to the exit in a conveying direction;
rails spaced apart across the width of the upper run and extending along the length of the upper run from first ends to second ends downstream of the first ends and forming lanes along the length of the conveyor belt separated by the rails;
electromagnetic coil sets extending upstream from the first ends of the rails toward the entrance of the upper run, wherein each of the electromagnetic coil sets is in line with one of the rails;
wherein the electromagnetic coil sets produce magnetic fields that interact with the electrically conductive articles to repel the electrically conductive articles and force a mass of the electrically conductive articles received at the entrance of the upper run to form files between consecutive electromagnetic coil sets for delivery to the first ends of the rails in line with the lanes.

2. The conveyor as claimed in claim 1 wherein the electrically conductive articles contain aluminum.

3. The conveyor as claimed in claim 2 wherein the electrically conductive articles are cans.

4. The conveyor as claimed in claim 1 wherein the files are single files of the electrically conductive articles.

5. The conveyor as claimed in claim 1 wherein upstream ends of the electromagnetic coil sets decrease in distance from the entrance away from first and second sides of the upper run toward the centerline of the upper run.

6. The conveyor as claimed in claim 1 comprising a first side rail along the first side of the upper run and a second side rail along the second side of the upper run, each of the side rails forming outermost lanes with the outermost rails.

7. The conveyor as claimed in claim 6 wherein the first and second side rails extend from the entrance of the upper run.

8. The conveyor as claimed in claim 6 wherein the rails and the first and second side rails each include two rail bars.

9. The conveyor as claimed in claim 1 wherein the electromagnetic coil sets are disposed in the upper run below an upper run of the conveyor belt.

10. The conveyor as claimed in claim 1 wherein the rails are linear and parallel to each other.

11. The conveyor as claimed in claim 1 wherein the rails are elevated above the conveyor belt across a gap shorter than the heights of the electrically conductive articles.

12. The conveyor as claimed in claim 1 wherein the entrance to the upper run is restricted to a narrower width than the width of the upper run between the first and second sides.

13. A method for organizing a mass of electrically conductive articles into lanes for delivery to lane-forming rails, the method comprising:
feeding a mass of electrically conductive articles onto a conveyor belt advancing in a conveying direction along an upper run from an entrance to an exit;
conveying the electrically conductive articles from the entrance to the exit on a conveying surface of the conveyor belt;
forming lanes spaced apart across the width of the conveyor between rails extending along the upper run above the conveying surface in the conveying direction from a first end nearer the entrance to a second end;
producing magnetic fields in electromagnetic coil sets extending in line with the rails from the first ends of the rails toward the entrance to repel the electrically conductive articles and force the mass of electrically conductive articles received at the entrance of the upper run to form files between consecutive electromagnetic coil sets for delivery to the first ends of the rails already aligned with the lanes.

14. The method as claimed in claim 13 comprising positioning the electromagnetic coil sets in the upper run below the conveying surface of the conveyor belt.

15. The method as claimed in claim 13 wherein the lengths of the electromagnetic coil sets vary across the upper run.

16. The method as claimed in claim 15 wherein the lengths of the electromagnetic coil sets increase with distance from opposite first and second sides of the upper run toward the centerline of the upper run.
